(19) United States
(12) Patent Application Publication
(10) Pub. No.: US 2012/0154678 A1
(43) Pub. Date: Jun. 21, 2012

(54) RECEIVING DEVICE, SCREEN FRAME TRANSMISSION SYSTEM AND METHOD

(76) Inventors: Kuo-Lung CHANG, Junghe City (TW); Hsing-Yung Wang, Junghe City (TW); Kuan-Yu Chou, Junghe City (TW); Meng-Chung Hung, Junghe City (TW); Chin-Jung Fan, Junghe City (TW); Li-Ger Chen, Junghe City (TW)

(21) Appl. No.: 12/973,532

(22) Filed: Dec. 20, 2010

(51) Int. Cl. H04N 5/04

(52) U.S. Cl. 348/500; 348/E05.009

(57) ABSTRACT

A screen frame transmission method includes a transmitting end capturing screen frame data and transmitting the screen frame data to a receiving end, and detecting for a user's operation and outputting a mode switching signal; a receiving end buffering the screen frame data transmitted by the transmitting end based on which a display device updates its screen, and according to the mode switching signal, switching to the operating mode or the video mode, wherein during the video mode, a longer playback period of the screen frame data are buffered, and during an operating mode, a shorter playback period of the screen frame data are buffered. According to the aforementioned method, during the video mode, the video may be played back smoothly; during the operating mode, a low latency delay control experience may be provided. A receiving device and screen frame transmission system realizing the above method are also disclosed.

### BACKGROUND OF THE INVENTION

1. Field of the Invention

The present invention relates to a receiving device, screen frame transmission system and method, and more particularly to a receiving device, screen frame transmission system and method capable of adjusting latency delay according to human interface device (HID) status.

2. Description of the Prior Art

Screen sharing is an important application of information technology. Examples of screen sharing include remote desktop control, or wirelessly connecting a computer with a projector for a presentation and so on. In the past, screen sharing technology is suitable only for the transmission of more static contents owing to lower frame rate, but with the continuous progress of computer performance, image compression technology and wireless network bandwidth, the screen sharing technology now allows smoothly viewing a video played in a remote desktop through a wireless network. In this field, the screen frame data may be obtained losslessly by an operating system through a software program.

During transmission of screen frames of the prior art remote desktop system, the receiving end usually does not buffer the screen frame data so that the latency delay between the transmission of the screen frame on the transmitting end and the display of the screen frame on the receiving end is reduced. However, buffering of screen frame data on the receiving end is necessary if smoothness during the wireless transmission of the desktop including the video content is desired. Because in most of network transmission environments, particularly wireless networks, the arrival times of the transmitted packages at the receiving end are not uniform, buffering of the screen frame data on the receiving end becomes essential in maintaining a playback rate on the receiving end that is smooth and jitter free. However, when the receiving end buffers the screen frame data, the latency delay between the transmission of the screen frame on the transmitting end and the display of the screen frame on the receiving end would increase. The larger the latency delay, the less interactive the remote control and the further away from the real-time control experience desired by a user. For example, when a user hit a keyboard remotely, it may take 2 to 3 seconds before the displaying screen shows the response, which hinders the user from controlling the remote host with ease.

In summary, it is highly desirable to provide a screen transmission method and system that maintains the smoothness of the video during playback while providing a low latency delay control experience when operations are performed to the host.

### SUMMARY OF THE INVENTION

The present invention is directed to a receiving device, screen transmission system and method that detect for operations of a user to control a system to switch between an operating mode and a video mode. During the operating mode, less screen frame data would be buffered so that latency delay for displaying the screen is reduced, thereby providing the user a low latency delay control experience. During the video mode, more screen frame data would be buffered, thereby enabling a smoother video playback.

According to an embodiment, a screen frame transmission system includes a transmitting device and a receiving device. The transmitting device includes a capturing module for capturing screen frame data; a first communicating interface for converting the screen frame data into a communicating signal and transmitting the communicating signal; and a first processing unit electrically connected with the capturing module and the first communicating interface for processing the screen frame data and transmitting the screen frame data through the first communicating interface. The receiving device includes a second communicating interface for receiving the communicating signal; a buffer for buffering the screen frame data so that based on the screen frame data a display device updates its screen; a second detecting module for detecting for an operation of a user and outputting a corresponding mode switching signal for an operating mode or a video mode; and a second processing unit electrically connected with the second communicating interface, the buffer and the second detecting module, and for accessing the buffer, and based on the mode switching signal, controlling the receiving device to switch to the operating mode or the video mode, wherein the buffer buffers a first playback period of the screen frame data in the video mode, and a second playback period of the screen frame data in the operating mode, and the first playback period is longer than the second playback period.

According to another embodiment, a receiving device forms a screen frame transmission system with a transmitting device. The receiving device includes a communicating interface, a buffer, a detecting module and a processing unit. The communicating interface is for receiving a communicating signal from the transmitting device which includes screen frame data. The buffer is for buffering the screen frame data so that based on the screen frame data, a display device updates its screen. The detecting module is for detecting for an operation of a user and outputting a corresponding mode switching signal for an operating mode or a video mode. The processing unit is electrically connected with the communicating interface, the buffer and the detecting module, and is for accessing the buffer, and according to the mode switching signal, controlling the receiving device to switch to the operating mode or the video mode, wherein the buffer buffers a first playback period of the screen frame data in the video mode, and a second playback period of the screen frame data in the operating mode, and the first playback period is longer than the second playback period.

According to yet another embodiment, a screen frame transmission method includes: capturing screen frame data on a transmitting end and transmitting the same to a receiving end; detecting for an operation of a user and outputting a corresponding mode switching signal for an operating mode or a video mode; receiving and buffering the screen frame data on the receiving end so that based on the screen frame data, a display device updates its screen; and switching to the operating mode or video mode according to the mode switching signal, wherein during the video mode, a first playback period of screen frame data are buffered, during the operating mode, a second playback period of screen frame data are buffered, and the first playback period is longer than the second playback period.

The objective, technologies, features and advantages of the present invention will become more apparent from the following description in conjunction with the accompanying drawings, wherein certain embodiments of the present invention are set forth by way of illustration and examples.

### BRIEF DESCRIPTION OF THE DRAWINGS

FIG. 1 is a block diagram illustrating the screen frame transmission system according to an embodiment of the present invention; and

FIG. 2 is a flow chart illustrating a screen frame transmission method according to an embodiment of the present invention.

### DESCRIPTION OF THE PREFERRED EMBODIMENT

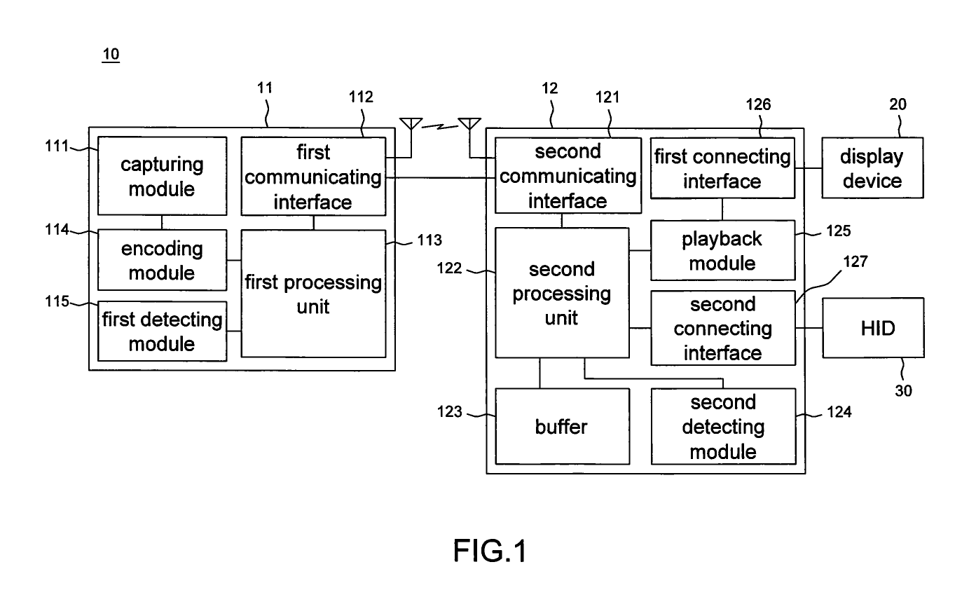

Referring to FIG. 1, there is illustrated a screen frame transmission system 10 according to an embodiment which includes a transmitting device 11 and a receiving device 12. The transmitting device 11 includes a capturing module 111, a first communicating interface 112 and a first processing unit 113. The capturing module 111 is for capturing screen frame data; e.g. the capturing module 111 may rely on the operating system to obtain the lossless screen frame data by a software program. The first communicating interface is for converting the captured screen frame data into a communicating signal and transmitting the communicating signal. The first processing unit 113 is electrically connected with the capturing module 111 and the first communicating interface 112 for processing the captured screen frame data from the capturing module 111 and transmitting the screen frame data through the first communicating interface 112. According to an embodiment, an encoding module for encoding the captured screen frame by the capturing module 111 may operate between the capturing module 111 and the first processing unit 113.

The receiver device 12 includes a second communicating interface 121, a buffer 123, a second detecting module 124 and a second processing unit 122. The second communicating interface 121 is for receiving the communicating signal from the transmitting device 11. According to an embodiment, the first communicating interface 112 and the second communicating interface 121 abide by a wired or wireless network communication standard. The second processing unit 122 is electrically connected with the second communicating interface 121, the buffer 123 and the second detecting module 124. The second processing unit 122 receives the demodulated screen frame data from the second communicating interface 121 and stores the screen frame data in the buffer 123 according to needs, so that a display device 20, based on the screen frame data in the buffer 123, updates its screen.

The second detecting module 124 is for detecting for an operation of a user and outputting a corresponding mode switching signal for an operating mode or a video mode. For example, the second detecting module 124 detects for an input signal of a human interface device (HID) such as keyboard, mouse, etc., to determine if the user is performing an operation. If an input signal of the HID is detected, which indicates the user is undergoing an operation, the second detecting module 124 outputs the mode switching signal for the operating mode; if there has not been any input signal of the HID detected for a predetermined period of time, which indicates the user has stopped the operation, the second detecting module 124 then outputs the mode switching signal for the video mode.

Continuing the above description, the second processing unit 122 can, based on the mode switching signal of the second detecting module 124, control the receiving device 12 to switch to the operating mode or the video mode. In the video mode, the second processing unit 122 buffers a first playback period of the screen frame data in the buffer 123; in the operating mode, the second processing unit 122 buffers a second playback period of the screen frame data in the buffer 123, wherein the first playback period is longer than the second playback period. In other words, during the video mode, the latency delay between the transmission of the screen frame on the transmitting device 11 and the display of the screen frame on the receiving end 12 is longer; on the other hand, during the operating mode, the latency delay is shorter. It is foreseeable that the shorter the second playback period, the shorter the latency delay between the transmission of the screen frame on the transmitting device 11 and the display of the screen frame on the receiving device 12.

According to an embodiment, the second processing unit 122 may rely on a playback module 125 to playback the screen frame data in the buffer 123. For example, the playback module 125 may be but not limited to be realized in software. During the video mode, the playback module 125 waits for a predetermined buffering period before playing back the screen frame data stored in the buffer 123 according to their respective time stamps at the original playback rate. When the receiving device 12 switches from the video mode to the operating mode, in order to reduce the latency delay, the playback module 125 may output the buffered screen frame data during the video mode in an accelerated manner, such as by increasing the frame rate of the output video, i.e. the playback module 125 ignores the respective time stamps of the screen frame data and outputs the screen frame data stored in the buffer 123 at a more rapid playback rate. Alternatively, the playback module 125 may discard the screen frame data stored during the video mode directly. In this way, the screen frame data received by the receiving device 12 thereafter would be the screen frames during the operations of the user. Because the latency delay is shorter, the user may not even be aware of it, thereby providing a low latency delay control experience.

On the contrary, when the receiving device 12 switches from the operating mode to the video mode, the playback module 125 may pause outputting the screen frame data stored in the buffer 123 or reduce the output rate of the screen frame data stored in the buffer 123, such as by lowering the frame rate for outputting the video, so that the buffer 123 may store more screen frame data. When the screen frame data enough for a predetermined playback period has been accumulated, the playback module 125 may then output the screen frames in accordance with the respective time frames of the screen frame data at the original playback rate.

According to an embodiment, the receiving device 12 may be built-in to the display device 20. Alternatively, the receiving device 12 may include a first connecting interface 126 electrically connected with the second processing unit 122. The display device 20 may electrically connect with the receiving device through the first connecting interface 126. For example, the first connecting interface 124 may be a video connecting port; the display device 20 may be a television, display or projector, etc., an electronic device that can display frames.

According to an embodiment, the receiving device 12 may include a second connecting interface 127 electrically connected with the second processing unit 122. The HID 30 may connect electrically with the receiving device 12 through the second interface 127. In this manner, the user may operate the remote host through the HID 30 connected with the receiving device 12. For instance, the second connecting interface 127 may be a USB interface. According to the foregoing structure, the display device 20 without an inputting device, such as a projector, by connecting with the receiving device 12 including the HID 30, may allow the user to control the remote host such as selecting the video to be played.

It is noted that the transmitting device 11 may also include a first detecting module 115 electrically connected with the first processing unit 113. The first detecting module 115 is similarly for detecting for an operation of the user and outputting the corresponding mode switching signal to the receiving device 12. The receiving device 12, based on the mode switching signal from the transmitting device 11, switches to the corresponding playback mode. For example, the user may not operate the remote host through the HID connected with the receiving device 11, but rather perform operations using a wireless keyboard or wireless mouse, and the receiving device 12 still can, based on the mode switching signal output from the transmitting device 11, switch to the corresponding playback mode so as to provide a low latency delay control experience.

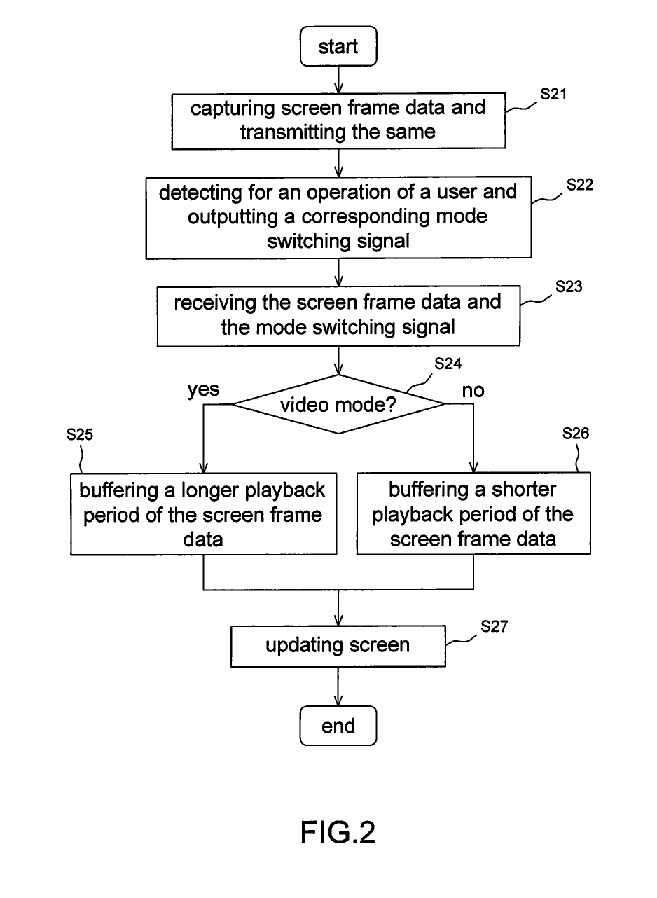

Referring to FIG. 2, there is illustrated a screen frame transmission method according to an embodiment. First, a transmitting end captures screen frame data and transmits the screen frame data to a receiving end (S21). The transmitting end or the receiving end detects for an operation of a user and outputs a corresponding mode switching signal for an operating mode or a video mode (S22). Then, the receiving end receives and buffers the screen frame data transmitted by the transmitting end and the mode switching signal (S23). The receiving end, based on the mode switching signal, determines whether to switch to the operating mode or the video mode (S24). If switched to the video mode, the transmitting end buffers a longer playback period of the screen frame data (S25), so that the latency delay between the transmission of the screen frame on the transmitting end and the display of the screen frame on the receiving end is longer, and the video playback would be smoother. If switched to the operating mode, the receiving end buffers a shorter playback period of screen frame data (S26), so that the latency delay between the transmission of the screen frame on the transmitting end and the display of the screen frame on the receiving end is shorter, thereby providing the user to have a low latency delay control experience. Lastly, the display device, based on the screen frame data buffered on receiving end, updates its screen (S27). Other detail description has been provided above and is omitted here.

To summarize the foregoing description, the receiving device, screen frame transmission system and method detect for a user's operation to control the system to switch between an operating mode and a video mode, wherein during the operating mode, less screen frame data are buffered so that the latency delay for displaying the screen frame is shorter, providing the user a low latency delay control experience; during the video mode, more screen frame data are buffered, so that the video playback is smoother.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A screen frame transmission system, comprising:
a transmitting device comprising:
a capturing module for capturing screen frame data;
a first communicating interface for converting the screen frame data into a communicating signal and transmitting the communicating signal; and
a first processing unit electrically connected with the capturing module and the first communicating interface for processing the screen frame data and transmitting the screen frame data through the first communicating interface; and
a receiving device comprising:
a second communicating interface for receiving the communicating signal;
a buffer for buffering the screen frame data so that based on the screen frame data a display device updates its screen;
a second detecting module for detecting for an operation of a user and outputting a corresponding mode switching signal for an operating mode or a video mode; and
a second processing unit electrically connected with the second communicating interface, the buffer and the second detecting module, and for accessing the buffer, and based on the mode switching signal, controlling the receiving device to switch to the operating mode or the video mode, wherein the buffer buffers a first playback period of the screen frame data in the video mode, and a second playback period of the screen frame data in the operating mode, and the first playback period is longer than the second playback period.

2. The screen frame transmission system according to claim 1, wherein when switched to the operating mode, the buffered screen data during the video mode are discarded or output in an accelerated manner.

3. The screen frame transmission system according to claim 1, wherein when switched to the video mode, output of the screen frame data is paused or decelerated and a normal output rate is not resumed until an amount of screen frame data enough for the first playback period has been accumulated.

4. The screen frame transmission system according to claim 1, wherein the second detecting module detects for an input signal of a human interface device to determine if the user is performing an operation.

5. The screen frame transmission system according to claim 1, wherein when the second detecting module has not detected any input signal of a human interface device for a predetermined period of time, the second detecting module outputs the corresponding mode switching signal for the video mode.

6. The screen frame transmission system according to claim 1, wherein the receiving device comprises a first connecting interface electrically connected with the second processing unit for the display device to electrically connect with the receiving device therethrough.

7. The screen frame transmission system according to claim 1, wherein the receiving device comprises a second connecting interface electrically connected with the second processing unit, for a human interface device to electrically connect with the receiving device therethrough.

8. The screen frame transmission system according to claim 1, wherein the transmitting device comprises a first detecting module electrically connected with the first processing unit for detecting for an operation of the user and outputting the corresponding mode switching signal to the receiving device.

9. The screen frame transmission system according to claim 1, wherein the transmitting device comprises an encoding module operating between the capturing module and the first processing unit for encoding the screen frame data.

10. A receiving device forming a screen frame transmission system with a transmitting device, the transmitting device transmitting a communicating signal comprising screen frame data, and the receiving device comprising:
a communicating interface for receiving the communicating signal;
a buffer for buffering the screen frame data so that based on the screen frame data, a display device updates its screen;
a detecting module for detecting for an operation of a user and outputting a corresponding mode switching signal for an operating mode or a video mode; and
a processing unit electrically connected with the communicating interface, the buffer and the detecting module, and for accessing the buffer, and according to the mode switching signal, controlling the receiving device to switch to the operating mode or the video mode, wherein the buffer buffers a first playback period of the screen frame data in the video mode, and a second playback period of the screen frame data in the operating mode, and the first playback period is longer than the second playback period.

11. The receiving device according to claim 10, wherein when switched to the operating mode, the buffered screen frame data during the video mode are discarded or output in an accelerated manner.

12. The receiving device according to claim 10, wherein when switched to the video mode, output of the screen frame data is paused or decelerated and a normal output rate is not resumed until an amount of screen frame data enough for the first playback period has been accumulated.

13. The receiving device according to claim 10, further comprising a first connecting interface electrically connected with the second processing unit for the display device to electrically connect with the receiving device therethrough.

14. The receiving device according to claim 10, further comprising a second connecting interface electrically connected with the processing unit, for a human interface device to electrically connect with the receiving device therethrough.

15. A screen frame transmission method, comprising:
capturing screen frame data on a transmitting end and transmitting the same to a receiving end;
detecting for an operation of a user and outputting a corresponding mode switching signal for an operating mode or a video mode;
receiving and buffering the screen frame data on the receiving end so that based on the screen frame data, a display device updates its screen; and
switching to the operating mode or video mode according to the mode switching signal, wherein during the video mode, a first playback period of screen frame data are buffered, during the operating mode, a second playback period of screen frame data are buffered, and the first playback period is longer than the second playback period.

16. The screen frame transmission method according to claim 15, wherein when switched to the operating mode, the receiving end discards or outputs in an accelerated manner the buffered screen data during the video mode.

17. The screen frame transmission method according to claim 15, wherein when switched to the video mode, the receiving end pauses or decelerates output of the screen frame data and resume a normal output rate only after an amount of screen frame data enough for the first playback period has been accumulated.

18. The screen frame transmission method according to claim 15, wherein the detecting step detects for an input signal of a human interface device to determine if the user is performing an operation.

19. The screen frame transmission method according to claim 15, wherein the detecting step comprises when the input signal has not been detected for a predetermined period of time, outputting the corresponding mode switching signal for the video mode.

20. The screen frame transmission method according to claim 15, wherein the detecting step is performed by one of the transmitting end and the receiving end.
